(19) United States
(12) Patent Application Publication
(10) Pub. No.: US 2011/0268962 A1
(43) Pub. Date: Nov. 3, 2011

(54) ULTRA-HIGH MOLECULAR WEIGHT POLYETHYLENE COMPRISING REFRACTORY PARTICLES

(75) Inventors: Sanjay Rastogi, Eindhoven (NL); Sara Ronca, Loughborough (GB)

(73) Assignee: TEIJIN ARAMID B.V., Arnhem (NL)

(21) Appl. No.: 13/143,981

(22) PCT Filed: Jan. 6, 2010
(86) PCT No.: PCT/EP10/50064

§ 371 Date: Jul. 11, 2011

(30) Foreign Application Priority Data
Jan. 9, 2009 (EP) 09150307.8

(51) Int. Cl. B32B 5/16; C08K 3/34; C08K 3/04; C08K 3/26; C08K 3/20; C08K 3/28; C08L 23/06; C08K 3/22; B82Y 30/00

(52) U.S. Cl. 428/325; 524/585; 524/445; 524/496; 524/413; 524/430; 524/497; 524/493; 524/424; 524/401; 524/428; 977/773; 977/742; 977/788; 977/811; 977/832

(57) ABSTRACT

Ultra-high molecular weight polyethylene including 0.001 to 10 weight % of refractory particles, wherein the refractory particles have an average particle size (D50) below 300 nm. The average particle size is at least 5 nm, in particular at least 10 nm, and/or at most 150 nm, in particular at most 100 nm, more in particular at most 80 nm. The particles are of transformation toughened zirconia.

The present invention pertains to ultra-high molecular weight polyethylene (UHMWPE) comprising refractory particles, to a method for manufacturing such ultra-high molecular weight polyethylene, to shaped objects, in particular films and fibres comprising said polyethylene, and to ballistic materials comprising elongate bodies comprising this material.

Polyethylene is one of the most commonly known polymers. It is applied in numerous applications. One of the more recent developments is the use of polyethylene in ballistic materials.

EP 1627719 describes a ballistic resistant article consisting essentially of ultra-high molecular weight polyethylene which comprises a plurality of unidirectionally oriented polyethylene sheets cross-plied at an angle with respect to each other and attached to each other in the absence of any resin, bonding matrix, or the like.

EP 833742 describes a ballistic resistant moulded article containing a compressed stack of monolayers, with each monolayer containing unidirectionally oriented fibres and at most 30 wt. % of an organic matrix material. The fibres may be polyethylene fibres.

There is still room form improving the ballistic properties of ultra-high molecular weight polyethylene, in particular solvent-free UHMWPE, more in particular of drawn solvent-free UHMWPE. It has now been found that the ballistic properties of ultra-high molecular weight polyethylene can be substantially improved by incorporating nanoparticles therein.

CN1431342 describes gel-spinning a composite of UHMWPE and 0.01-5 wt. % carbon nanotubes. The use of carbon nanotubes leads to improved heat resistance and creep.

C. Piconi and G. Maccauro (Biomaterials 20 (1999), p. 1-25) describes the influence of zirconia in UHMWPE on wear. The particle size of the zirconia is not mentioned.

U.S. Pat. No. 6,558,794 describes incorporating ceramic powders into UHMWPE. The PE is then formed into an orthopedic implant via pressure-thermoforming.

U.S. Pat. No. 5,200,379 describes olefin polymerisation catalysts adsorbed on an activated inorganic refractory compounds, e.g., inorganic oxides or metal phosphates. Particle size of the carrier is not given.

It has been found that the use of refractory particles with the specified size and in the specified amount results in an increased ballistic performance of the polymer without substantially affecting the other properties of the material.

The refractory particles are used in an amount of 0.001 to 10 weight %, calculated on the total of polyethylene and refractory particles. If the amount of particles is too low, the effect of the present invention will not be obtained. If the amount of particles is too high, the performance of the polyethylene will not be further improved, while the presence of the particles may start to detrimentally affect the properties of the polymer. The amount of particles will in particular be at least 0.01 wt. %, still more in particular at least 0.05 wt. %. The amount of particles will in particular be at most 5 wt. %, still more in particular at most 3 wt. %. The exact amount of particles will also depend on the size of the particles. If the particles are relatively small, a smaller amount of particles will suffice to obtain the effect of the present invention.

The particles used in the present invention have an average particle size (D50) below 300 nm. The particle size (D50) is defined as the median particle size at the 50^{th} percentile, where 50% of the particles (by number) are greater than the D50 and 50% are smaller than the D50. The particle size distribution may be determined via dynamic light scattering. Depending on the nature of the particles, where the particles are present in a polymer matrix, the polymer matrix can be removed, for example by heating the material to burn off the polymer, followed by determination of the particle size. The particle size can also be determined via scanning electron microscopy or transmission electron microscopy or via other suitable methods known in the art. It is within the scope of the skilled person to select a suitable method.

More in particular, the average particle size is at least 1 nm, in particular at least 5 nm, still more in particular at least 10 nm. The average particle size may be at most 200 nm, in particular at most 150 nm, more in particular at most 100 nm, even more in particular at most 80 nm.

The refractory particles used in the process according to the invention are generally selected from particles of inorganic oxides, inorganic hydroxides, inorganic carbonates, inorganic carbides, inorganic nitrides, carbon nanotubes, clays, and combinations thereof.

In one embodiment, the refractory particles are selected from oxides of aluminium, silicium, titanium, zirconium, and combinations thereof.

In one embodiment, particles of zirconium oxide (zirconia) are used in the present invention. The use of transformation-toughened zirconium oxide may be particularly preferred. Transformation-toughened zirconia, which is commercially available, has a microstructure in which the zirconia is in the tetragonal phase. When transformation toughened zirconia is put under stress, the material will transform from the tetragonal phase into the monoclinic phase. This phase transformation is accompanied by expansion of the material. Thus, when transformation-toughened zirconia is put under stress, the expansion of the material caused by the phase transformation will stop propagation of cracks formed in the material. Moreover, the presence of zirconia in the polymer matrix will promote delocalisation of stresses generated during impact, thus circumventing the brittle nature of ceramics. Accordingly, transformation-toughened zirconia is capable of absorbing substantial amounts of energy, and its presence in a ballistic material thus helps to dissipate impact energy.

In another embodiment, the refractory particles comprise a carbonate salt of an alkaline earth metal, for example calcium carbonate.

In a further embodiment, the refractory particles comprise a nitride or a carbide, in particular a nitride or carbide of silicon or boron.

In one embodiment, the refractory particles are nanotubes, for example carbon nanotubes or boron nitride nanotubes.

The polyethylene used in the present invention can be a homopolymer of ethylene or a copolymer of ethylene with a co-monomer which is another alpha-olefin or a cyclic olefin both with generally between 3 and 20 carbon atoms. Examples include propene, 1-butene, 1-pentene, 1-hexene, 1-heptene, 1-octene, cyclohexene, etc. The use of dienes with up to 20 carbon atoms is also possible, e.g., butadiene or 1-4 hexadiene. The amount of (non-ethylene) alpha-olefin in the ethylene homopolymer or copolymer used in the process according to the invention preferably is at most 10 mole %, preferably at most 5 mole %, more preferably at most 1 mole %. In the case that a (non-ethylene) alpha-olefin is used, it is generally present in an amount of at least 0.001 mol. %, in particular at least 0.01 mole %, still more in particular at least 0.1 mole %.

In the present invention the polyethylene is an ultra-high molecular weight polyethylene. An ultra-high molecular weight polyethylene is a polyethylene with a weight average molecular weight (Mw) of at least 500 000 gram/mole in particular between 1.10⁶ gram/mole and 1.10⁸ gram/mole. The molecular weight distribution and molecular weigh averages (Mw, Mn, Mz) of the polymer may be determined in accordance with ASTM D 6474-99 at a temperature of 160° C. using 1,2,4-trichlorobenzene (TCB) as solvent. Appropriate chromatographic equipment (PL-GPC220 from Polymer Laboratories) including a high temperature sample preparation device (PL-SP260) may be used. The system is calibrated using sixteen polystyrene standards (Mw/Mn<1.1) in the molecular weight range 5*10³ to 8*10⁶ gram/mole.

The molecular weight distribution may also be determined using melt rheometry. Prior to measurement, a polyethylene sample to which 0.5 wt % of an antioxidant such as IRGANOX 1010 has been added to prevent thermo-oxidative degradation, would first be sintered at 50° C. and 200 bars. Disks of 8 mm diameter and thickness 1 mm obtained from the sintered polyethylenes are heated fast (˜30° C./min) to well above the equilibrium melting temperature in the rheometer under nitrogen atmosphere. For an example, the disk was kept at 180 C for two hours or more. The slippage between the sample and rheometer discs may be checked with the help of an oscilloscope. During dynamic experiments two output signals from the rheometer i.e. one signal corresponding to sinusoidal strain, and the other signal to the resulting stress response, are monitored continuously by an oscilloscope. A perfect sinusoidal stress response, which can be achieved at low values of strain was an indicative of no slippage between the sample and discs.

Rheometry may be carried out using a plate-plate rheometer such as Rheometrics RMS 800 from TA Instruments. The Orchestrator Software provided by the TA Instruments, which makes use of the Mead algorithm, may be used to determine molar mass and molar mass distribution from the modulus vs frequency data determined for the polymer melt. The data is obtained under isothermal conditions between 160-220° C. To get the good fit angular frequency region between 0.001 to 100 rad/s and constant strain in the linear viscoelastic region between 0.5 to 2% should be chosen. The time-temperature superposition is applied at a reference temperature of 190° C. To determine the modulus below 0.001 frequency (rad/s) stress relaxation experiments may be performed. In the stress relaxation experiments, a single transient deformation (step strain) to the polymer melt at fixed temperature is applied and maintained on the sample and the time dependent decay of stress is recorded.

Ultra-high molecular weigh polyethylene is used in the present invention because in general it is well suitable for use in ballistic materials. In general, the UHMWPE used in the present invention has a polymer solvent content of less than 0.05 wt. %, in particular less than 0.025 wt. %, more in particular less than 0.01 wt. %.

It may be preferred for the ultra-high molecular weight polyethylene used in the present invention to have a relatively narrow molecular weight distribution. This is expressed by the Mw (weight average molecular weight) over Mn (number average molecular weight) ratio of at most 8. More in particular the Mw/Mn ratio is at most 6, still more in particular at most 4, even more in particular at most 2.

In one embodiment, an ultra-high molecular weight polyethylene is used which has an elastic shear modulus G_{N}⁰ determined directly after melting at 160° C. of at most 1.4 MPa, in particular 1.0 MPa, more in particular at most 0.9 MPa, still more in particular at most 0.8 MPa, more in particular at most 0.7 MPa. The wording “directly after melting” means that the elastic shear modulus is determined as soon as the polymer has melted, in particular within 15 seconds after the polymer has melted. For this polymer melt G_{N}⁰ typically increases from 0.6 to 2.0 MPa in one, two, or more hours, depending on the molar mass of the polymer. G_{N}⁰ is the elastic shear modulus in the rubbery plateau region. It is related to the average molecular weight between entanglements Me, which in turn is inversely proportional to the entanglement density. In a thermodynamically stable melt having a homogeneous distribution of entanglements, Me can be calculated from G_{N}⁰ via the formula G_{N}⁰=g_{N}ρRT/Mₑ, where g_{N} is a numerical factor set at 1, rho is the density in g/cm3, R is the gas constant and T is the absolute temperature in K. A low elastic shear modulus directly after melting stands for long stretches of polymer between entanglements, and thus for a low degree of entanglement. The adopted method for the investigation on changes in G_{N}⁰ with the entanglements formation is the same as described in publications (Rastogi, S., Lippits, D., Peters, G., Graf, R., Yefeng, Y. and Spiess, H., “Heterogeneity in Polymer Melts from Melting of Polymer Crystals”, Nature Materials, 4(8), 1 Aug. 2005, 635-641 and PhD thesis Lippits, D. R., “Controlling the melting kinetics of polymers; a route to a new melt state”, Eindhoven University of Technology, dated 6 Mar. 2007, ISBN 978-90-386-0895-2). It has been found that this type polymer is attractive for ballistic purposes.

In a particular embodiment of the invention, the polyethylene is a disentangled UHMWPE. In the present specification, the wording disentangled UHMWPE is characterised by a weight average molecular weight (Mw) of at least 500 000 gram/mole, a Mw/Mn ratio of at most 8, and an elastic modulus G_{N}⁰, determined directly after melting at 160° C. of at most 1.4 MPa. The preferred ranges given above for these parameters also apply to the present embodiment.

Where the polymer is a polymer with an elastic modulus G_{N}⁰, determined directly after melting at 160° C. of at most 1.4 MPa, it may be manufactured by a polymerisation process wherein ethylene, optionally in the presence of other monomers as discussed above, is polymerised in the presence of a single-site polymerisation catalyst at a temperature below the crystallisation temperature of the polymer, so that the polymer crystallises immediately upon formation. In particular, reaction conditions are selected such that the polymerisation speed is lower than the crystallisation speed. These synthesis conditions force the molecular chains to crystallize immediately upon their formation, leading to a rather unique morphology which differs substantially from the one obtained from the solution or the melt. The crystalline morphology created at the surface of a catalyst will strongly depend on the ratio between the crystallization rate and the growth rate of the polymer. Moreover, the temperature of the synthesis, which is in this particular case also crystallization temperature, will strongly influence the morphology of the obtained UHMWPE powder. In one embodiment the reaction temperature is between −50 and +50° C., more in particular between −15 and +30° C. It is well within the scope of the skilled person to determine via routine trial and error which reaction temperature is appropriate in combination with which type of catalyst, polymer concentrations and other parameters influencing the reaction.

To obtain a disentangled UHMWPE it is important that the polymerisation sites are sufficiently far removed from each other to prevent entangling of the polymer chains during synthesis. This can be done using a single-site catalyst which is dispersed homogenously through the crystallisation medium in low concentrations. More in particular, concentrations less than 1.10-4 mol catalyst per liter, in particular less than 1.10-5 mol catalyst per liter reaction medium may be appropriate. Supported single site catalyst may also be used, as long as care is taken that the active sites are sufficiently far removed from each other to prevent substantial entanglement of the polymers during formation.

Suitable methods for manufacturing starting UHMWPE used in the present invention are known in the art. Reference is made, for example to WO01/21668 and US20060142521.

The (disentangled) UHMWPE used in the process according to the invention preferably has a DSC crystallinity of at least 74%, more in particular at least 80%. The morphology of the films may be characterised using differential scanning calorimetry (DSC), for example on a Perkin Elmer DSC7. Thus, a sample of known weight (2 mg) is heated from 30 to 180° C. at 10° C. per minute, held at 180° C. for 5 minutes, then cooled at 10° C. per minute. The results of the DSC scan may be plotted as a graph of heat flow (mW or mJ/s; y-axis) against temperature (x-axis). The crystallinity is measured using the data from the heating portion of the scan. An enthalpy of fusion ΔH (in J/g) for the crystalline melt transition is calculated by determining the area under the graph from the temperature determined just below the start of the main melt transition (endotherm) to the temperature just above the point where fusion is observed to be completed. The calculated ΔH is then compared to the theoretical enthalpy of fusion (ΔH_{c} of 293 J/g) determined for 100% crystalline PE at a melt temperature of approximately 140° C. A DSC crystallinity index is expressed as the percentage 100(ΔH/ΔH_{c}).

The film in accordance with the invention and the intermediate products of the manufacturing process according to the invention preferably also have crystallinities as indicated above.

The disentangled UHMWPE that may be used in the present invention generally has a bulk density which is significantly lower than the bulk density of conventional UWMWPEs. More in particular, the UHMWPE used in the process according to the invention may have a bulk density below 0.25 g/cm³, in particular below 0.18 g/cm³, still more in particular below 0.13 g/cm³. The bulk density may be determined in accordance with ASTM-D1895. A fair approximation of this value can be obtained as follows. A sample of UHMWPE powder is poured into a measuring beaker of exact 100 ml. After scraping away the surplus of material, the weight of the content of the beaker is determined and the bulk density is calculated.

The present invention also pertains to a method for manufacturing the polyethylene composition according to the invention. More in particular, the present invention pertains to a method for manufacturing a polyethylene composition wherein ethylene is polymerised in the presence of a catalyst to form an ultra-high molecular weight polyethylene, wherein 0.001 to 10 weight % of refractory particles having an average particle size (D50) below 300 nm are added to the polyethylene before or after polymerisation of the ethylene to form ultra-high molecular weight polyethylene.

The polymerisation of ethylene itself is known in the art. In general it entails contacting ethylene with a polymerisation catalyst under such conditions of temperature and pressure that polymerisation takes place. Further elucidation of the general process is not required.

The refractory particles may be added to the polyethylene before or after polymerisation of the ethylene to form ultra-high molecular weight polyethylene.

Addition before polymerisation may, for example be carried out by preparing a dispersion of the particles in the solvent used for polymerisation. Examples of suitable solvents are aromatic and aliphatic hydrocarbons, such as hexane, heptane, cyclohexane, and toluene. For good order's sake I note that the solvent is not a solvent for the polyethylene. That is, the solubility of the polyethylene in the solvent below 50° C., in particular below 25° C. is negligible and should not influence the physical characteristics of the synthesised polymer.

Addition after polymerisation may, for example, be carried out by mixing the refractory particles through the polymer, for example by spraying the polymer with a dispersion of the particles in a solvent, or by high-energy ball-milling. Where a solvent is used in the application of the particles, the solvent may be removed by drying, for example under vacuum.

In one embodiment of the present invention, the refractory particles serve as carrier particles for the catalyst.

Surprisingly it has been found that the presence of the refractory particles hardly interferes with the processing of the ultra-high molecular weight polyethylene. Accordingly, the polyethylene containing refractory particles may be processed to form shaped products according to manners conventional in the art. This is in particular the case for disentangled ultra-high molecular weight polyethylene.

In one embodiment, the ultra-high molecular weight polyethylene, in particular the disentangled UHMWPE is converted to films using a solid state film manufacturing process comprising the steps of subjecting the starting ultra-high molecular weight polyethylene to a compacting step and a stretching step under such conditions that at no point during the processing of the polymer its temperature is raised to a value above its melting point. The compacting step is carried out to integrate the polymer particles into a single object, e.g., in the form of a mother sheet. The stretching step is carried out to provide orientation to the polymer and manufacture the final product. The two steps are carried out at a direction perpendicular to each other. It is noted that it is within the scope of the present invention to combine these elements in a single step, or to carry out the process in different steps, each step performing one or more of the compacting and stretching elements. For example, in one embodiment of the process according to the invention, the process comprises the steps of compacting the polymer powder to form a mothersheet, rolling the plate to form rolled mothersheet and subjecting the rolled mothersheet to a stretching step to form a polymer film.

The compacting force applied in the process according to the invention generally is 10-10000 N/cm², in particular 50-5000 N/cm2, more in particular 100-2000 N/cm². The density of the material after compacting is generally between 0.8 and 1 kg/dm³, in particular between 0.9 and 1 kg/dm³.

Where disentangled UHMWPE is used in the invention the compacting and rolling step is generally carried out at a temperature of at least 1° C. below the unconstrained melting point of the polymer, in particular at least 3° C. below the unconstrained melting point of the polymer, still more in particular at least 5° C. below the unconstrained melting point of the polymer. Generally, the compacting step is carried out at a temperature of at most 40° C. below the unconstrained melting point of the polymer, in particular at most 30° C. below the unconstrained melting point of the polymer, more in particular at most 10° C. In the process of this embodiment the stretching step is generally carried out at a temperature of at least 1° C. below the melting point of the polymer under process conditions, in particular at least 3° C. below the melting point of the polymer under process conditions, still more in particular at least 5° C. below the melting point of the polymer under process conditions. As the skilled person is aware, the melting point of polymers may depend upon the constraint under which they are put. This means that the melting temperature under process conditions may vary from case to case. It can easily be determined as the temperature at which the stress tension in the process drops sharply. Generally, the stretching step is carried out at a temperature of at most 30° C. below the melting point of the polymer under process conditions, in particular at most 20° C. below the melting point of the polymer under process conditions, more in particular at most 15° C.

The unconstrained melting temperature of the starting polymer is between 138 and 142° C. and can easily be determined by the person skilled in the art. With the values indicated above this allows calculation of the appropriate operating temperature. The unconstrained melting point may be determined via DSC (differential scanning calorimetry) in nitrogen, over a temperature range of +30 to +180° C. and with an increasing temperature rate of 10° C./minute. The maximum of the largest endothermic peak at from 80 to 170° C. is evaluated here as the melting point.

The stretching step in the process according to the invention is carried out to manufacture the polymer film. The stretching step may be carried out in one or more steps in a manner conventional in the art. A suitable manner includes leading the film in one or more steps over a set of rolls both rolling in process direction wherein the second roll rolls faster that the first roll. Stretching can take place, e.g., over a hot plate or in an air circulation oven.

In one embodiment of the present invention, in particular for disentangled polyethylene, the stretching step encompasses at least two individual stretching steps, wherein the first stretching step is carried out at a lower temperature than the second, and optionally further, stretching steps. In one embodiment, the stretching step encompasses at least two individual stretching steps wherein each further stretching step is carried out at a temperature which is higher than the temperature of the preceding stretching step. As will be evident to the skilled person, this method can be carried out in such a manner that individual steps may be identified, e.g., in the form of the films being fed over individual hot plates of a specified temperature. The method can also be carried out in a continuous manner, wherein the film is subjected to a lower temperature in the beginning of the stretching process and to a higher temperature at the end of the stretching process, with a temperature gradient being applied in between. This embodiment can for example be carried out by leading the film over a hot plate which is equipped with temperature zones, wherein the zone at the end of the hot plate nearest to the compaction apparatus has a lower temperature than the zone at the end of the hot plate furthest from the compaction apparatus. In one embodiment, the difference between the lowest temperature applied during the stretching step and the highest temperature applied during the stretching step is at least 3° C., in particular at least 7° C., more in particular at least 10° C. In general, the difference between the lowest temperature applied during the stretching step and the highest temperature applied during the stretching step is at most 30° C., in particular at most 25° C.

Depending on the properties of the polymer, the total stretching ratio of the film can be relatively high. For example, the total stretching ratio may be at least 80, in particular at least 100, more in particular at least 120, in particular at least 140, more in particular at least 160. The total stretching ratio is defined as the area of the cross-section of the compacted mothersheet divided by the cross-section of the drawn film produced from this mothersheet.

Where the polyethylene is disentangled polyethylene it has also been found that, as compared to conventional processing of UHMWPE, materials with a strength of at least 2 GPa can be manufactured at higher deformation speeds. The deformation speed is directly related to the production capacity of the equipment. For economical reasons it is important to produce at a deformation rate which is as high as possible without detrimentally affecting the mechanical properties of the film. In particular, it has been found that it is possible to manufacture a material with a strength of at least 2 GPa by a process wherein the stretching step that is required to increase the strength of the product from 1.5 GPa to at least 2 GPa is carried out at a rate of at least 4% per second. In conventional polyethylene processing it is not possible to carry out this stretching step at this rate. While in conventional UHMWPE processing the initial stretching steps, to a strength of, say, 1 or 1.5 GPa may be carried out at a rate of above 4% per second, the final steps, required to increase the strength of the film to a value of 2 GPa or higher, must be carried out at a rate well below 4% per second, as otherwise the film will break. In contrast, in the process according to the invention it has been found that it is possible to stretch intermediate film with a strength of 1.5 GPa at a rate of at least 4% per second, to obtain a material with a strength of at least 2 GPa. For further preferred values of the strength reference is made to what has been stated above. It has been found that the rate applied in this step may be at least 5% per second, at least 7% per second, at least 10% per second, or even at least 15% per second.

The strength of the film is related to the stretching ratio applied. Therefore, this effect can also be expressed as follows. In one embodiment of the invention, the stretching step of the process according to the invention can be carried out in such a manner that the stretching step from a stretching ratio of 80 to a stretching ratio of at least 100, in particular at least 120, more in particular at least 140, still more in particular of at least 160 is carried out at the stretching rate indicated above.

In still a further embodiment, the stretching step of the process according to the invention can be carried out in such a manner that the stretching step from a material with a modulus of 60 GPa to a material with a modulus of at least at least 80 GPa, in particular at least 100 GPa, more in particular at least 120 GPa, at least 140 GPa, or at least 150 GPa is carried out at the rate indicated above.

In will be evident to the skilled person that the intermediate products with a strength of 1.5 GPa, a stretching ratio of 80, and/or a modulus of 60 GPa are used, respectively, as starting point for the calculation of when the high-rate stretching step starts. This does not mean that a separately identifyable stretching step is carried out where the starting material has the specified value for strength, stretching ratio, or modulus. A product with these properties may be formed as intermediate product during a stretching step. The stretching ratio will then be calculated back to a product with the specified starting properties. It is noted that the high stretching rate described above is dependent upon the requirement that all stretching steps, including the high-rate stretching step or steps are carried out at a temperature below the melting point of the polymer under process conditions.

The present invention also pertains to shaped objects comprising the polyethylene comprising refractory particles according to the invention. Shaped objects are, for example, films, tapes, fibres, filaments, and products which contain these materials, such as ropes, cables, nets, fabrics, and protective appliances such as ballistic resistant moulded articles.

In one embodiment, the present invention pertains to polyethylene films which have a have a tensile strength of at least 1.0 GPa, a tensile modulus of at least 40 GPa, and a tensile energy-to-break of at least 15 J/g and which comprise 0.001 to 10 weight % of refractory particles, wherein the refractory particles have an average particle size (D50) below 300 nm.

In one embodiment, the tensile strength is at least 1.2 GPa, more in particular at least 1.5 GPa, still more in particular at least 1.8 GPa, even more in particular at least 2.0 GPa, still more in particular at least 2.5 GPa, more in particular at least 3.0 GPa, still more in particular at least 4 GPa. Tensile strength is determined in accordance with ASTM D882-00.

In another embodiment, the tensile modulus is at least 50 GPa. The modulus is determined in accordance with ASTM D822-00. More in particular, the tensile modulus is at least 80 GPa, more in particular at least 100 GPa, still more in particular at least 120 GPa, even more in particular at least 140 GPa, or at least 150 GPa. In another embodiment, the tensile energy to break is at least 20 J/g, in particular at least 25 J/g, more in particular at least 30 J/g, even more in particular at least 35 J/g, still more in particular at least 40 J/g, or at least 50 J/g. The tensile energy to break is determined in accordance with ASTM D882-00 using a strain rate of 50%/min. It is calculated by integrating the energy per unit mass under the stress-strain curve.

In one embodiment of the present invention, the films have a 200/110 uniplanar orientation parameter Φ of at least 3. The 200/110 uniplanar orientation parameter Φ is defined as the ratio between the 200 and the 110 peak areas in the X-ray diffraction (XRD) pattern of the tape sample as determined in reflection geometry.

Wide angle X-ray scattering (WAXS) is a technique that provides information on the crystalline structure of matter.

The technique specifically refers to the analysis of Bragg peaks scattered at wide angles. Bragg peaks result from long-range structural order. A WAXS measurement produces a diffraction pattern, i.e. intensity as function of the diffraction angle 2θ (this is the angle between the diffracted beam and the primary beam).

The 200/110 uniplanar orientation parameter gives information about the extent of orientation of the 200 and 110 crystal planes with respect to the tape surface. For a tape sample with a high 200/110 uniplanar orientation the 200 crystal planes are highly oriented parallel to the tape surface. It has been found that a high uniplanar orientation is generally accompanied by a high tensile strength and high tensile energy to break. The ratio between the 200 and 110 peak areas for a specimen with randomly oriented crystallites is around 0.4. However, in the tapes that are preferentially used in one embodiment of the present invention the crystallites with indices 200 are preferentially oriented parallel to the film surface, resulting in a higher value of the 200/110 peak area ratio and therefore in a higher value of the uniplanar orientation parameter.

The value for the 200/110 uniplanar orientation parameter may be determined using an X-ray diffractometer. A Bruker-AXS D8 diffractometer equipped with focusing multilayer X-ray optics (Göbel mirror) producing Cu-Kα radiation (K wavelength=1.5418 \acute{Å}) is suitable. Measuring conditions: 2 mm anti-scatter slit, 0.2 mm detector slit and generator setting 40 kV, 35 mA. The tape specimen is mounted on a sample holder, e.g. with some double-sided mounting tape. The preferred dimensions of the tape sample are 15 mm×15 mm (l×w). Care should be taken that the sample is kept perfectly flat and aligned to the sample holder. The sample holder with the tape specimen is subsequently placed into the D8 diffractometer in reflection geometry (with the normal of the tape perpendicular to the goniometer and perpendicular to the sample holder). The scan range for the diffraction pattern is from 5° to 40° (2θ) with a step size of 0.02° (2θ) and a counting time of 2 seconds per step. During the measurement the sample holder spins with 15 revolutions per minute around the normal of the tape, so that no further sample alignment is necessary. Subsequently the intensity is measured as function of the diffraction angle 2θ. The peak area of the 200 and 110 reflections is determined using standard profile fitting software, e.g. Topas from Bruker-AXS. As the 200 and 110 reflections are single peaks, the fitting process is straightforward and it is within the scope of the skilled person to select and carry out an appropriate fitting procedure. The 200/110 uniplanar orientation parameter is defined as the ratio between the 200 and 110 peak areas. This parameter is a quantitative measure of the 200/110 uniplanar orientation.

As indicated above, in one embodiment the films have a 200/110 uniplanar orientation parameter of at least 3. It may be preferred for this value to be at least 4, more in particular at least 5, or at least 7. Higher values, such as values of at least 10 or even at least 15 may be particularly preferred. The theoretical maximum value for this parameter is infinite if the peak area 110 equals zero. High values for the 200/110 uniplanar orientation parameter are often accompanied by high values for the strength and the energy to break.

The shaped object according to the invention may also be a fibre. For the fibres the same preferred ranges apply as have been specified above for the films.

Suitable fibres can be obtained from the films as described above, e.g., via slitting. The process as described above will yield tapes. They can be converted into fibres via methods known in the art, e.g., via slitting. They can also be obtained via a process comprising subjecting a polyethylene tape with a weight average molecular weight of at least 100 000 gram/mole, an Mw/Mn ratio of at most 6, and a 200/110 uniplanar orientation parameter of at least 3 to a force in the direction of the thickness of the tape over the whole width of the tape. Again, for further elucidation and preferred embodiments as regards the molecular weight and the Mw/Mn ratio of the starting tape, reference is made to what has been stated above.

In one embodiment of the present invention, the fibres have a 020 uniplanar orientation parameter of at most 55°. The 020 uniplanar orientation parameter gives information about the extent of orientation of the 020 crystal planes with respect to the fiber surface.

The 020 uniplanar orientation parameter is measured as follows. The sample is placed in the goniometer of the diffractometer with the machine direction perpendicular to the primary X-ray beam. Subsequently the intensity (i.e. the peak area) of the 020 reflection is measured as function of the goniometer rotation angle Φ. This amounts to a rotation of the sample around its long axis (which coincides with the machine direction) of the sample. This results in the orientation distribution of the crystal planes with indices 020 with respect to the filament surface. The 020 uniplanar orientation parameter is defined as the Full Width at Half Maximum (FWHM) of the orientation distribution.

The measurement can be carried out using a Bruker P4 with HiStar 2D detector, which is a position-sensitive gas-filled multi-wire detector system. This diffractometer is equipped with graphite monochromator producing Cu-Kα radiation (K wavelength=1.5418 Å). Measuring conditions: 0.5 mm pinhole collimator, sample-detector distance 77 mm, generator setting 40 kV, 40 mA and at least 100 seconds counting time per image. The fiber specimen is placed in the goniometer of the diffractometer with its machine direction perpendicular to the primary X-ray beam (transmission geometry). Subsequently the intensity (i.e. the peak area) of the 020 reflection is measured as function of the goniometer rotation angle Φ. The 2D diffraction patterns are measured with a step size of 1° (Φ) and counting time of at least 300 seconds per step.

The measured 2D diffraction patterns are corrected for spatial distortion, detector non-uniformity and air scattering using the standard software of the apparatus. It is within the scope of the skilled person to effect these corrections. Each 2-dimensional diffraction pattern is integrated into a 1-dimensional diffraction pattern, a so-called radial 2θ curve. The peak area of the 020 reflections is determined by a standard profile fitting routine, with is well within the scope of the skilled person. The 020 uniplanar orientation parameter is the FWHM in degrees of the orientation distribution as determined by the peak area of the 020 reflection as function of the rotation angle Φ of the sample.

As indicated above, in one embodiment of the present invention fibres are used which have a 020 uniplanar orientation parameter of at most 55°. The 020 uniplanar orientation parameter preferably is at most 45°, more preferably at most 30°. In some embodiments the 020 uniplanar orientation value may be at most 25°. It has been found that fibres which have a 020 uniplanar orientation parameter within the stipulated range have a high strength and a high elongation at break.

Like the 200/110 uniplanar orientation parameter, the 020 uniplanar orientation parameter is a measure for the orientation of the polymers in the fiber. The use of two parameters derives from the fact that the 200/110 uniplanar orientation parameter cannot be used for fibers because it is not possible position a fiber sample adequately in the apparatus. The 200/110 uniplanar orientation parameter is suitable for application onto bodies with a width of 0.5 mm or more. On the other hand, the 020 uniplanar orientation parameter is in principle suitable for materials of all widths, thus both for fibers and for tapes. However, this method is less practical in operation than the 200/110 method. Therefore, in the present specification the 020 uniplanar orientation parameter will be used only for fibers with a width smaller than 0.5 mm.

In one embodiment, the width of the film is generally at least 5 mm, in particular at least 10 mm, more in particular at least 20 mm, still more in particular at least 40 mm. The width of the film is generally at most 200 mm. The thickness of the film is generally at least 8 microns, in particular at least 10 microns. The thickness of the film is generally at most 150 microns, more in particular at most 100 microns. In one embodiment, films are obtained with a high strength, as described above, in combination with a high linear density. In the present application the linear density is expressed in dtex. This is the weight in grams of 10.000 metres of film. In one embodiment, the film according to the invention has a denier of at least 3000 dtex, in particular at least 5000 dtex, more in particular at least 10000 dtex, even more in particular at least 15000 dtex, or even at least 20000 dtex, in combination with strengths of, as specified above, at least 2.0 GPa, in particular at least 2.5 GPA, more in particular at least 3.0 GPa, still more in particular at least 3.5 GPa, and even more in particular at least 4.

As indicated above, it has been found that the ultra-high molecular weight polyethylene comprising refractory particles with the stipulated properties show improved ballistic performance as compared to the same polyethylene not containing said refractory particles. Accordingly, the present invention also pertains to a ballistic-resistant moulded article comprising a compressed stack of sheets comprising reinforcing elongate bodies, wherein at least some of the elongate bodies are ultra-high molecular weight polyethylene elongate bodies which comprise 0.001 to 10 weight % of refractory particles having an average particle size (D50) below 300 nm. For preferred embodiments as regards the nature and amount of particles, the polyethylene, and the properties of the shaped objects, reference is made to what has been stated above.

Within the context of the present specification the word elongate body means an object the largest dimension of which, the length, is larger than the second smallest dimension, the width, and the smallest dimension, the thickness. More in particular, the ratio between the length and the width generally is at least 10. The maximum ratio is not critical to the present invention and will depend on processing parameters. As a general value, a maximum length to width ratio of 1 000 000 may be mentioned.

Accordingly, the elongate bodies used in the present invention encompass monofilaments, multifilament yarns, threads, tapes, strips, staple fibre yarns and other elongate objects having a regular or irregular cross-section.

Within the present specification, the term sheet refers to an individual sheet comprising elongate bodies, which sheet can individually be combined with other, corresponding sheets. The sheet may or may not comprise a matrix material, as will be elucidated below.

As indicated above, at least some of the elongate bodies in the ballistic-resistant moulded article are ultra-high molecular weight polyethylene elongated bodies meeting the stated requirements. To obtain the effect of the present invention, it is preferred for at least 20 wt. %, calculated on the total weight of the elongated bodies present in the ballistic resistant moulded article, of the elongated bodies to be polyethylene elongate bodies meeting the requirements of the present invention, in particular at least 50 wt. %. More in particular, at least 75 wt. %, still more in particular at least 85 wt. %, or at least 95 wt. % of the elongated bodies present in the ballistic resistant moulded article meets said requirements. In one embodiment, all of the elongated bodies present in the ballistic resistant moulded article meet said requirements.

The sheets may encompass the reinforcing elongate bodies as parallel fibers or tapes. When tapes are used, they may be next to each other, but if so desired, they may partially or wholly overlap. The elongate bodies may be formed as a felt, knitted, or woven, or formed into a sheet by any other means.

The compressed stack of sheets may or may not comprise a matrix material. The term “matrix material” means a material which binds the elongate bodies and/or the sheets together. When matrix material is present in the sheet itself, it may wholly or partially encapsulates the elongate bodies in the sheet. When the matrix material is applied onto the surface of the sheet, it will act as a glue or binder to keep the sheets together.

In one embodiment of the present invention, the sheet does not contain a matrix material. the sheet may be manufactured by the steps of providing a layer of elongate bodies and where necessary adhering the elongate bodies together by the application of heat and pressure. It is noted that this embodiment requires that the elongate bodies can in fact adhere to each other by the application of heat and pressure.

In one embodiment of this embodiment, the elongate bodies overlap each other at least partially, and are then compressed to adhere to each other. This embodiment is particularly attractive when the elongate bodies are in the form of tapes.

If so desired, a matrix material may be applied onto the sheets to adhere the sheets to each other during the manufacture of the ballistic material. The matrix material can be applied in the form of a film or, preferably, in the form of a liquid material.

The organic matrix material, if used, may wholly or partially consist of a polymer material, which optionally may contain fillers usually employed for polymers. The polymer may be a thermoset or thermoplastic or mixtures of both. Preferably a soft plastic is used, in particular it is preferred for the organic matrix material to be an elastomer with a tensile modulus (at 25° C.) of at most 41 MPa. The use of non-polymeric organic matrix material is also envisaged. The purpose of the matrix material is to help to adhere the elongated bodies and/or the sheets together where required, and any matrix material which attains this purpose is suitable as matrix material.

Preferably, the elongation to break of the organic matrix material is greater than the elongation to break of the reinforcing elongate bodies. The elongation to break of the matrix preferably is from 3 to 500%. These values apply to the matrix material as it is in the final ballistic-resistant article.

Thermosets and thermoplastics that are suitable for the sheet are listed in for instance EP833742 and WO-A-91/12136. Preferably, vinylesters, unsaturated polyesters, epoxides or phenol resins are chosen as matrix material from the group of thermosetting polymers. These thermosets usually are in the sheet in partially set condition (the so-called B stage) before the stack of sheets is cured during compression of the ballistic-resistant moulded article. From the group of thermoplastic polymers polyurethanes, polyvinyls, polyacrylates, polyolefins or thermoplastic, elastomeric block copolymers such as polyisoprene-polyethylenebutylene-polystyrene or polystyrene-polyisoprenepolystyrene block copolymers are preferably chosen as matrix material.

In the case that a matrix material is used in the compressed stack in accordance with the invention, the matrix material is present in the compressed stack in an amount of 0.2-40 wt. %, calculated on the total of elongate bodies and organic matrix material. The use of more than 40 wt. % of matrix material was found not to further increase the properties of the ballistic material, while only increasing the weight of the ballistic material. Where present, it may be preferred for the matrix material to be present in an amount of at least 1 wt. %, more in particular in an amount of at least 2 wt. %, in some instances at least 2.5 wt. %. Where present, it may be preferred for the matrix material to be present in a amount of at most 30 wt. %, sometimes at most 25 wt. %.

In one embodiment of the present invention, a relatively low amount of matrix material is used, namely an amount in the range of 0.2-8 wt. %. In this embodiment it may be preferred for the matrix material to be present in an amount of at least 1 wt. %, more in particular in an amount of at least 2 wt. %, in some instances at least 2.5 wt. %. In this embodiment it may be preferred for the matrix material to be present in a amount of at most 7 wt. %, sometimes at most 6.5 wt. %.

The compressed sheet stack of the present invention should meet the requirements of class II of the NIJ Standard—0101.04 P-BFS performance test. In a preferred embodiment, the requirements of class IIIa of said Standard are met, in an even more preferred embodiment, the requirements of class III are met, or the requirements of other classes, such as class IV. This ballistic performance is preferably accompanied by a low areal weight, in particular an areal weight of at most 19 kg/m2, more in particular at most 16 kg/m2. In some embodiments, the areal weight of the stack may be as low as 15 kg/m2. The minimum areal weight of the stack is given by the minimum ballistic resistance required.

The ballistic-resistant material according to the invention preferably has a peel strength of at least 5N, more in particular at least 5.5 N, determined in accordance with ASTM-D 1876-00, except that a head speed of 100 mm/minute is used. Depending on the final use and on the thickness of the individual sheets, the number of sheets in the stack in the ballistic resistant article according to the invention is generally at least 2, in particular at least 4, more in particular at least 8. The number of sheets is generally at most 500, in particular at most 400.

In one embodiment of the present invention the direction of elongate bodies within the compressed stack is not unidirectionally. This means that in the stack as a whole, elongate bodies are oriented in different directions.

In one embodiment of the present invention the elongate bodies in a sheet are unidirectionally oriented, and the direction of the elongate bodies in a sheet is rotated with respect to the direction of the elongate bodies of other sheets in the stack, more in particular with respect to the direction of the elongate bodies in adjacent sheets. Good results are achieved when the total rotation within the stack amounts to at least 45 degrees. Preferably, the total rotation within the stack amounts to approximately 90 degrees. In one embodiment of the present invention, the stack comprises adjacent sheets wherein the direction of the elongated bodies in one sheet is perpendicular to the direction of elongated bodies in adjacent sheets. It is noted that the sheets in this embodiment may in themselves comprise overlapping parallel elongate bodies, e.g., in a bricklayered arrangement as discussed above.

The invention also pertains to a method for manufacturing a ballistic-resistant moulded article comprising the steps of providing sheets comprising reinforcing elongate bodies at least some of which are polyethylene elongate bodies which comprise 0.001 to 10 weight % of refractory particles having an average particle size (D50) below 300 nm, stacking the sheets and compressing the stack under a pressure of at least 0.5 MPa.

In one embodiment of the present invention the sheets are stacked in such a manner that the direction of the elongated bodies in the stack is not unidirectionally.

In one embodiment of this process, the sheets are provided by providing a layer of elongate bodies and causing the bodies to adhere. This can be done by the provision of a matrix material, or by compressing the bodies as such. In the latter embodiment it may be desired to apply matrix material onto the sheets before stacking.

The pressure to be applied is intended to ensure the formation of a ballistic-resistant moulded article with adequate properties. The pressure is at least 0.5 MPa. A maximum pressure of at most 80 MPA may be mentioned.

Where necessary, the temperature during compression is selected such that the matrix material is brought above its softening or melting point, if this is necessary to cause the matrix to help adhere the elongate bodies and/or sheets to each other. Compression at an elevated temperature is intended to mean that the moulded article is subjected to the given pressure for a particular compression time at a compression temperature above the softening or melting point of the organic matrix material and below the softening or melting point of the elongate bodies.

The required compression time and compression temperature depend on the kind of elongate body and matrix material and on the thickness of the moulded article and can be readily determined by one skilled in the art.

Where the compression is carried out at elevated temperature, the cooling of the compressed material should also take place under pressure. Cooling under pressure is intended to mean that the given minimum pressure is maintained during cooling at least until so low a temperature is reached that the structure of the moulded article can no longer relax under atmospheric pressure. It is within the scope of the skilled person to determine this temperature on a case by case basis. Where applicable it is preferred for cooling at the given minimum pressure to be down to a temperature at which the organic matrix material has largely or completely hardened or crystallized and below the relaxation temperature of the reinforcing elongate bodies. The pressure during the cooling does not need to be equal to the pressure at the high temperature. During cooling, the pressure should be monitored so that appropriate pressure values are maintained, to compensate for decrease in pressure caused by shrinking of the moulded article and the press.

Depending on the nature of the matrix material, for the manufacture of a ballistic-resistant moulded article in which the reinforcing elongate bodies in the sheet are high-drawn elongate bodies of high-molecular weight linear polyethylene, the compression temperature is preferably 115 to 135° C. and cooling to below 70° C. is effected at a constant pressure. Within the present specification the temperature of the material, e.g., compression temperature refers to the temperature at half the thickness of the moulded article.

In the process of the invention the stack may be made starting from loose sheets. Loose sheets are difficult to handle, however, in that they easily tear in the direction of the elongate bodies. It may therefore be preferred to make the stack from consolidated sheet packages containing from 2 to 50 sheets. In one embodiment, stacks are made containing 2-8 sheets. In another embodiment, stacks are made of 10-30 sheets. For the orientation of the sheets within the sheet packages, reference is made to what has been stated above for the orientation of the sheets within the compressed stack.

Consolidated is intended to mean that the sheets are firmly attached to one another. Very good results are achieved if the sheet packages, too, are compressed.

The present invention is elucidated by the following example, without being limited thereto or thereby.

### EXAMPLE

A particulate disentangled polyethylene with a molecular weight of 10×10⁶ g/mole was combined with 6 wt. % of zirconia with an average particle size of 30 nm. The polyethylene was free from polymer solvent. The sample was subjected to compaction followed by two-stage drawing. The compaction took place at a temperature of 125 C, the drawing at a temperature of 135 C. The final tape had a strength of 2.6 GPa. It is to be noted that even in the presence of zirconia particles it was possible to draw the disentangled PE to form a high-strength material. The resulting tapes had a width of 1 cm.

A test shield was manufactured as follows. Monolayers of adjacent tapes were prepared. The monolayers were provided with a matrix material. The monolayers were then stacked, with the tape direction of the tapes in adjacent monolayers being rotated with 90°. This sequence was repeated until a stack of 8 monolayers was obtained. The stack was compressed for 12.5 minutes at a pressure of about 100 bar at a temperature of 130° C. The thus-obtained test shields had a matrix content of about 5 wt. %, and a size of about 115×115 mm.

The shield was tested as follows. The shield was fixed in a frame. An aluminium bullet with a weight of 0.57 gram is fired at the center or the corner of the shield. The velocity of the bullet is measured before it enters the shield and when it has left the shield. The consumed energy is calculated from the difference in velocity, and the specific consumed energy is calculated. The results are presented in the table below.

| | | | | | | SCE |
|---|---|---|---|---|---|---|
| | | | | | con- | specific |
| | shield | areal | bullet | bullet | sumed | consumed |
| | weight | weight | velocity | velocity | energy | energy |
| | (g) | (kg/m2) | 1 (m/s) | 2 (m/s) | (J) | (J) |
| center | 2.85 | 0.23 | 351 | 338 | 2.4 | 10.5 |
| corner 1 | 2.85 | 0.23 | 350 | 337 | 2.6 | 11.2 |
| corner 2 | 2.85 | 0.23 | 348 | 335 | 2.5 | 10.6 |

1. An ultra-high molecular weight polyethylene comprising 0.001 to 10 weight % of refractory particles, wherein the refractory particles have an average particle size (D50) below 300 nm.

2. The ultra-high molecular weight polyethylene according to claim 1, wherein the amount of particles is at least 0.01 wt % and at most 5 wt. %.

3. The ultra-high molecular weight polyethylene according to claim 1 wherein the refractory particles are selected from the group consisting of inorganic oxides, inorganic hydroxides, inorganic carbonates, inorganic carbides, inorganic nitrides, carbon nanotubes, clays, and combinations thereof.

4. The ultra-high molecular weight polyethylene according to claim 3, wherein the refractory particles are oxides selected from the group consisting of aluminium, silicium, titanium, zirconium, and combinations thereof.

5. The ultra-high molecular weight polyethylene according to claim 1, wherein the average particle size is at least 5 nm and at most 150 nm.

6. The ultra-high molecular weight polyethylene according to claim 1, which is a disentangled ultra-high molecular weight polyethylene.

7. A method for manufacturing an ultra-high molecular weight polyethylene composition comprising:
polymerizing ethylene in the presence of a catalyst to form ultra-high molecular weight polyethylene, and
adding 0.001 to 10 weight % of refractory particles having an average particle size (D50) below 300 nm to the polyethylene before or after polymerizing the ethylene to form ultra-high molecular weight polyethylene.

8. A shaped object comprising ultra-high molecular weight polyethylene according to claim 1.

9. The shaped object according to claim 8 which is a film with a tensile strength of at least 1.0 GPa, a tensile modulus of at least 40 GPa, and a tensile energy-to-break of at least 15 J/g.

10. The shaped object according to claim 8, which is a fibre with a tensile strength of at least 1.0 GPa, a tensile modulus of at least 40 GPa, and a tensile energy-to-break of at least 15 J/g.

11. A ballistic-resistant moulded article comprising a compressed stack of sheets comprising reinforcing elongate bodies, wherein at least some of the elongate bodies are ultra-high molecular weight polyethylene elongate bodies which comprise 0.001 to 10 weight % of refractory particles having an average particle size (D50) below 300 nm.

12. The ultra-high molecular weight polyethylene according to claim 1, wherein the amount of particles is at least 0.05 wt. % and at most 3 wt. %.

13. The ultra-high molecular weight polyethylene according to claim 3, wherein the refractory particles are oxides of zirconium.

14. The ultra-high molecular weight polyethylene according to claim 3, wherein the refractory particles are oxides of transformation toughened zirconia.

15. The ultra-high molecular weight polyethylene according to claim 1, wherein the average particle size is at least 10 nm and at most 100 nm.

16. The ultra-high molecular weight polyethylene according to claim 1, wherein the average particle size is at least 10 nm and at most 80 nm.
